(19) United States
(12) Patent Application Publication
(10) Pub. No.: US 2006/0122829 A1
(43) Pub. Date: Jun. 8, 2006

(54) Method for constructing acoustic model and acoustic model-based exploring method in speech recognition system

(75) Inventor: Hoon Kim, Anyang-si (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/292,990

(22) Filed: Dec. 2, 2005

(30) Foreign Application Priority Data
Dec. 2, 2004 (KR) 10-2004-0100597

(51) Int. Cl. G10L 19/02

(52) U.S. Cl. 704/229

(57) ABSTRACT

A method for constructing an acoustic model and an acoustic model-based exploring method in a speech recognition system are provided. In the method, an arrangement A that corresponds to N phonemes, and an arrangement M storing phoneme weights that belong to upper index weights among N phonemes in an order of indexes, are generated. A phoneme index position is explored from the arrangement A and the number of bits set at 1 of up to the location where the phoneme index is positioned according to a weight thereof is obtained. A phoneme index weight inputted from an arrangement M is explored using the number of bits set at 1.

This application claims the benefit of the Korean Patent Application No. 10-2004-0100597, filed on Dec. 2, 2004, which is hereby incorporated by reference as if fully set forth herein.

### BACKGROUND OF THE INVENTION

1. Field of the Invention

The present invention relates to a method for constructing an acoustic model and an acoustic model-based exploring method in a speech recognition system.

2. Description of the Related Art

Speech recognition is a series of processes for extracting linguistic information such as a phoneme from acoustic information contained in a voice to allow a machine to recognize the linguistic information and react thereto. That is, the speech recognition is a process for converting a voice signal into a code so that a machine may operate using the voice.

Conversation using voices is considered as a most natural and convenient way among information exchange medium between human being and a machine. Therefore, a speech recognition technology is used for small-sized terminals such as portable phones and personal digital assistants (PDAs). To realize the speech recognition technology in a system having a limited calculation ability and a limited storage space such as the small-sized terminals, a technology for realizing calculation of a speech recognition algorithm and reducing a memory used therein, is highly required.

Generally, the speech recognition requires a memory for storage space for network construction for object vocabularies, realization of an exploring algorithm, and an acoustic model for extracting the characteristics of voices and modeling using probability. The acoustic model occupies the largest portion of the storage space. Therefore, it is important to reduce the capacity of the acoustic model so as to realize the speech recognition technology in the small-sized terminal such as a portable terminal.

In designing the acoustic model for the speech recognition, a speech characteristic vector space is quantized (vector quantization (VQ)) into N to make a codebook. An elementary unit when making an acoustic model is called ‘phoneme’. Designing speech recognition using adjacent front phoneme and adjacent rear phoneme is called ‘triphone’. Assuming that forty phonemes are used, 6,400 (40×40×40=6,4000) triphones theoretically exist but generally 2,000 triphones are generated.

Since respective phoneme models have N weights with respect to a space vector-quantized into N, depending on importance, M×N bytes are required to express M triphones. Here, the weight, which has a value between 0 and 1, is multiplied to a Gaussian distribution when calculating recognition probability. Even when weights having values other than the upper N/2 weights among N weights are replaced by a predetermined constant, a recognition rate dose not change. Therefore, a storage space actually required for storing the weights is N/2, not N.

However, when only N/2 weights are stored, information as to how original arrangements are mapped is additionally required. For example, assuming that weights are W1=0.2, W2=0.3, W3=0.2, W4=0.3, when W[1], W[2], W[3], W[4] are stored in W′[1], W′[2], W′[3], W′[4], respectively, then N arrangements are also additionally required. Accordingly, despite an actually required value is N/2, storage spaces for (N/2+N) are required. Since an additional storage space for storing arrangement information is required besides a space for storing a weight of each phoneme in vector-quantizing a phoneme model for the speech recognition, a memory space shortage is generated when realizing a speech recognition system in a small-sized terminal.

### SUMMARY OF THE INVENTION

Accordingly, the present invention is directed to a method for constructing an acoustic model and an acoustic model-based exploring method in a speech recognition system that substantially obviate one or more problems due to limitations and disadvantages of the related art.

An object of the present invention is to provide a method for constructing an acoustic model and an acoustic model-based exploring method in a speech recognition system, capable of reducing a memory space by realizing an acoustic model (modeling voice characteristics using probability distribution so as to recognize speeches) using an efficient algorithm.

Another object of the present invention is to provide a method for constructing an acoustic model and an acoustic model-based exploring method in a speech recognition system, capable of reducing a memory space that stores the weights of respective phonemes for realizing an acoustic model, and reducing a time for exploring the weight of a relevant index.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for constructing an acoustic model in a speech recognition system including: an arrangement A expressing N phoneme index weights; an arrangement M expressing upper weights in an order of original indexes with respect to respective phonemes; an arrangement B expressing the number of bits set as information indicating an upper weight with respect to the respective phonemes; an arrangement C expressing a position set as information indicating the upper weight; an arrangement D expressing a quotient obtained by dividing a phoneme index by a unit of expression; an arrangement E expressing a remainder obtained by dividing a phoneme index by a unit of expression; and an arrangement F expressing a remainder obtained by dividing a phoneme index by a unit of expression in terms of an exponent of 2.

In another aspect of the present invention, there is provided a method for constructing an acoustic model in a speech recognition system including: an arrangement A constructed by allowing N phonemes to correspond to respective bits in N/8−1 bytes; an arrangement M constructed by arranging weights that correspond to upper N/2 of N phonemes in an order of indexes; an arrangement B expressing weight indexes that correspond to upper N/2 in terms of the number of bits set at 1; an arrangement C expressing a position set at 1; an arrangement D expressing a quotient obtained by dividing the phoneme index by 8; an arrangement E expressing a remainder of the quotient obtained by dividing the phoneme index by 8; and an arrangement F expressing a remainder L of the quotient obtained by dividing the phoneme index by 8 in terms of F[L]=2^{L}.

In a further another aspect of the present invention, there is provided an acoustic modeling-based exploring method in a speech recognition system, the method including: inputting a phoneme index; exploring a relevant phoneme index position from an arrangement A expressing N phoneme index weights; when the explored weight belongs to upper N/2 index weights, calculating the number S of information expressing the explored weight is a weight that belongs to the upper N/2 index weights of up to the phoneme index position; and exploring a weight for the S from an arrangement M[S] expressing upper weights in an order of original indexes with respect to respective phonemes.

In a still further another aspect of the present invention, there is provided an acoustic modeling-based exploring method in a speech recognition system, the method including: setting an arrangement A constructed by allowing N phonemes to correspond to respective bits in N/8−1 bytes, an arrangement M constructed by arranging weights that correspond to upper N/2 of N phonemes in an order of phoneme indexes, an arrangement B expressing weight indexes that correspond to upper N/2 in terms of the number of bits set at 1, an arrangement C expressing positions set at 1, an arrangement D expressing quotients obtained by dividing the phoneme index by 8, an arrangement E expressing remainders of the quotients obtained by dividing the phoneme index by 8, and an arrangement F expressing remainders Ls of the quotients obtained by dividing the phoneme indexes by 8 in terms of F[L]=2^{L}; inputting a phoneme index; obtaining a quotient K and a remainder L thereof obtained by dividing the inputted phoneme index by 8; judging whether an operation result of A[K] AND F[L] is greater than 1 to judge whether the inputted phoneme has a weight that belongs to upper N/2 index weights; when the judgment result is greater than 1, obtaining the number of bits set at 1 when considering the range of up to an L-th bit of a K-th byte using an operation J=A[K] AND C[L], and the number of bits set at 1 when considering the range of up to a K-th byte using an operation I=B[A[0]]+B[A[1]]+ . . . +B[A[K−1]]; and obtaining I+B[J]=S from the operation results, and applying the S to the arrangement M to output M[S] as a exploring result for a phoneme index weight.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating the configuration of an arrangement A[16] according to an embodiment of the present invention;

FIG. 2 is a view illustrating the configuration of an arrangement B[256] according to an embodiment of the present invention;

FIG. 3 is a view illustrating the configuration of an arrangement C[8] according to an embodiment of the present invention;

FIG. 4 is a view illustrating the configuration of arrangements D[128], E[128], and F[8] according to an embodiment of the present invention;

FIG. 5 a view illustrating the configuration of an arrangement M[64] according to an embodiment of the present invention; and

FIG. 6 is a view illustrating a flowchart of a method for exploring an arrangement of phoneme indexes according to an embodiment of the present invention.

### DETAILED DESCRIPTION OF THE INVENTION

Reference will now be made in detail to the preferred embodiments of the present invention, examples of which are illustrated in the accompanying drawings.

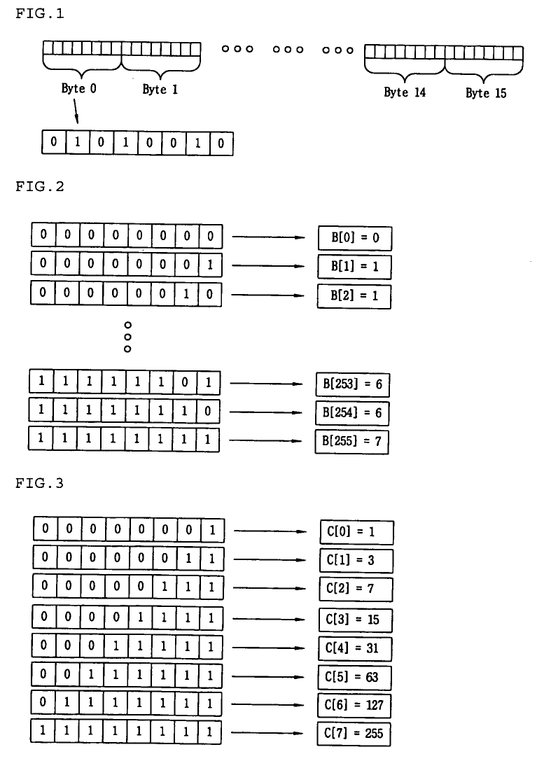

FIGS. 1 to 5 are views illustrating configurations of arrangements A[16], B[256], C[8], D[128], M[64] associated with phoneme information of an acoustic model according to an embodiment of the present invention. Respective arrangements are used to realize a process for understanding original arrangement information of phonemes.

FIG. 1 is a view illustrating the configuration of the arrangement A[16]. Referring to FIG. 1, since 1 byte consists of 8 bits, weights that correspond to indexes of 0-127 are expressed using 16 bytes, i.e., 128 bits. Here, bits that correspond to indexes whose weights belong to upper 64 weights among 128 weights are expressed with 1, and the rest of the bits are expressed with 0 with respect to each phoneme. Therefore, zeroth byte may express indexes 0-7, first byte may express indexes 8-15, and fifteenth byte may express indexes 120-127 using 0 or 1.

FIG. 2 is a view illustrating the configuration of the arrangement B[256]. Referring to FIG. 2, the arrangement B[256] expresses the number of bits set to 1 with respect to 256 numbers (0-255) that may be expressed using 1 byte. For example, in the case of B[253], the number 253 may be expressed in terms of a binary number ‘11111101’. Since the number of bits set to 1 is 6, B[253] is 6.

FIG. 3 is a view illustrating the configuration of the arrangement C[8]. Referring to FIG. 3, the arrangement C[8] is an arranged used for understanding a position set to 1. The arrangement C[8] is an arrangement where, C[0], C[1], and C[2] are expressed by ‘00000001’, ‘00000011’, and ‘00000111’, respectively. In this manner, the arrangement C[8] may express the position of 1 up to C[7]. Each of the arrangement C[8] has a decimal number converted from a binary number thereof. Therefore, C[0], C[1], and C[2] have decimal numbers 1, 3, and 7, respectively.

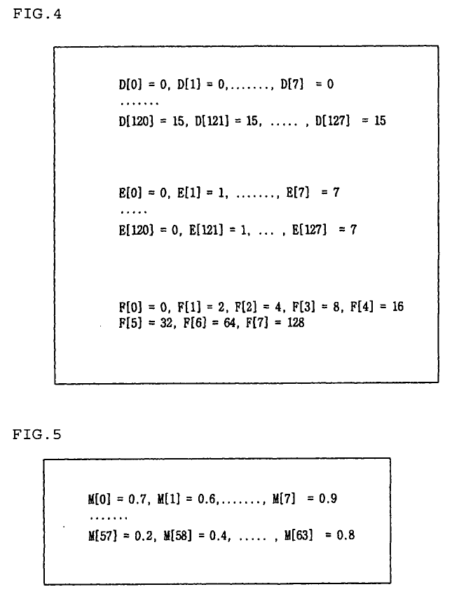

FIG. 4 is a view illustrating the configurations of arrangements D[128], E[128], and F[8]. Referring to FIG. 4, the arrangement D[128] represents quotients obtained by dividing relevant indexes by 8, the arrangement E[128] represents remainders of the quotients obtained by dividing the relevant indexes by 8, and the arrangement F[8] represents values applied to the arrangement F[8] as expressed in terms of exponents of 2. For example, since D[110] has a quotient 13 as obtained by dividing 110 by 8, D[110]=13. Since E[110] has a remainder 6 as obtained by dividing 110 by 8, E[110]=6. Also, since L is 6 in F[6]=2^{L}, F[6]=2⁶=64.

FIG. 5 is a view illustrating the configuration of the arrangement M[64]. Referring to FIG. 5, the arrangement M[64] stores weights that correspond to upper 64 weights of 128 weights in an order of original indexes with respect to respective phonemes. For example, assuming that indexes 0, 3, . . . , 110, 113, . . . , and 127 are indexes that correspond to upper 64 weights, M[0]=0.7[0], M[1]=0.6[3], . . . , M[7]=0.9[11], . . . , M[57]=0.2[110], M[58]=0.4[113], . . . , and M[63]=0.8[127].

The arrangements A[16] and M[64] of the above-described arrangements are arrangements differently generated for each phoneme and the arrangements B[256] and C[8] are arrangements used in common.

When the phoneme index is inputted, whether the weight of the phoneme that corresponds to the inputted phoneme index belongs to upper 64 index weights is judged, and a position of the arrangement storing the upper 64 index weights where the weight of the phoneme is stored is explored. A method for theses operations will be described.

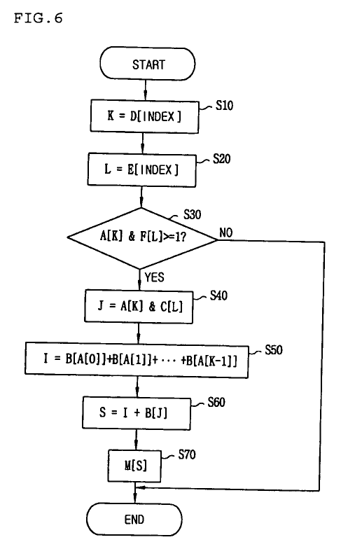

FIG. 6 is a view illustrating a flowchart of a method for exploring a phoneme index weight according to an embodiment of the present invention. When the phoneme index is inputted, D[index] is calculated to define K (S10), and E[index] is calculated to define L (S20). That is, since the arrangement D[128] of FIG. 4 expresses quotients obtained by dividing the indexes by 8, K=D[index] is calculated. Also, since the arrangement E[128] of FIG. 4 expresses remainders obtained by dividing the indexes by 8, L=E[index] is calculated.

After that, a value of the arrangement A for the above calculated K, i.e., A[K] is calculated, and, a value of the arrangement F for the above calculated L, i.e., F[L] is calculated, and then these A[K] and F[L] are bit-operated (AND), that is, A[K] AND F[L] is performed. Next, whether the result of the A[K] AND F[L] is greater than 1 is judged (S30). At this point, when the result of the AND operation is greater than 1, a phoneme that corresponds to the inputted index has a weight that belongs to the upper 64 index weights. Otherwise, the phoneme has a weight that does not belong to the upper 64 index weights, and thus the phoneme has a weight replaced by a constant.

Therefore, when the result of the AND operation is greater than 1, it is judged that the phoneme that corresponds to the inputted index has a weight that belongs to the upper 64 index weights, and an original arrangement of that index is explored (S40-S70).

To explore the index arrangement of the phoneme having a weight belonging to the upper 64 index weights, a value of the arrangement A for the above calculated K, i.e., A[K] is calculated, and a value of the arrangement C for the above calculated L, i.e., C[L] (C in FIG. 3 is an arrangement expressing a position set to 1) is calculated, and then these A[K] and C[L] are AND-operated, that is, J=A[K] AND C[L] is calculated (S40). As a result, J means the position of a bit set at 1 when considering the range from zeroth bit to an L-th bit of a K-th byte with respect to K, which is a quotient obtained by dividing an inputted phoneme index by 8, and L, which is a remainder thereof.

Next, after values (A[0], A[1], . . . , and A[K−1]) of the arrangement A for 0 to (K−1) are calculated, and values (B[A[0]], B[A[1]], . . . , and B[A[K−1]]) of the arrangement B for respective values of the arrangement A are calculated. Next, above-calculated values of the arrangement B for respective values of the arrangement A are summed, that is, I(=B[A[0]]+B[A[1]]+ . . . B[A[K−1]]) is calculated (S50). As a result, I means the number of bits set at 1 when considering the range from zeroth byte to a (K−1)th byte with respect to K, which is a quotient obtained by dividing an inputted phoneme index by 8, and L, which is a remainder thereof.

Subsequently, when the values of the arrangement B with respect to the J, i.e., B[J] are calculated, the number of bits set to 1 when considering the range from zeroth bit to an L-th bit of the K-th byte may be calculated, and then the B[J] and the I are summed to obtain S=I+B[J] (S60). As a result, S means the number of bits set at 1 when considering the range from zeroth byte to an L-th bit of a K-th byte that correspond to phoneme indexes. Next, the values of the arrangement M for S, i.e., M[S] are calculated, so that weights mapped from the arrangement M with respect to the relevant indexes may be obtained, and these values are outputted as results (S70).

Whether the weight of an index 110 belongs to the upper 64 index weights, and determining of the position of the index weight in the arrangement storing the upper 64 index weights the weight will be described below using the method for exploring the phoneme index weights illustrated in FIG. 6.

First, when 110 is divided by 8, a quotient K thereof is 13 and a remainder L thereof is 6. Thus, when the sixth bit of the thirteenth byte is examined, whether the weight of a phoneme that corresponds to an index 110 belongs to the upper 64 index weights is judged. Such judgment may be made by judging whether A[13] AND F[6]≧1. Assuming that A[13] is 83, A[13] is 0101011 in terms of a binary number and F[6], which is 2⁶, is 01000000 in terms of a binary number, so that the AND operation value thereof is 01000000, which is greater than 1. Therefore, the index 110 is an index having a weight belonging to the upper 64 index weights.

Also, the position of the index weight in the arrangement storing the upper 64 index weights is known by determining which of the bits in the fourteen bytes is set at 1, where the thirteenth byte is determined considering only the first six bits. The number of bits set at 1 may be calculated using I=B[A[0]]+B[A[1]]+ . . . +B[A[K−1]] for the range from zeroth byte up to twelveth byte. The number of bits set at 1 may be obtained by finding out the values of A[13] AND C[6] from the arrangement B for the range from zeroth bit to sixth bit in the thirteenth byte. Here, since A[13] is 01010011 and C[6] is 01111111, 83 which is a decimal number of 01010011 (the value of A[K] AND C[L]) is explored from the arrangement B. Next, S, which is a sum of I and B[83], is obtained. The S is applied to the arrangement M, so that the weight of the inputted phoneme index may be obtained.

According to the present invention, even when the size of the acoustic model for the speech recognition is reduced, the recognition rate does not change, and the arrangement values are calculated using a bit operation so that a recognition time may be performed in real-time. Therefore, the speech recognition may be efficiently realized in a system having limited memory capacity or limited operation resources such as a portable terminal.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for constructing an acoustic model in a speech recognition system comprising:
an arrangement A expressing N phoneme index weights;
an arrangement M expressing upper weights in an order of original indexes with respect to respective phonemes;
an arrangement B expressing the number of bits set as information indicating an upper weight with respect to the respective phonemes;
an arrangement C expressing a position set as information indicating an upper weight;
an arrangement D expressing a quotient obtained by dividing a phoneme index by a unit of expression;
an arrangement E expressing a remainder obtained by dividing a phoneme index by a unit of expression; and
an arrangement F expressing a remainder obtained by dividing a phoneme index by a unit of expression in terms of an exponent of 2.

2. The method according to claim 1, wherein the arrangement A allows the N phoneme index weights to correspond to the respective bits in N/8−1 bytes and stores the same.

3. The method according to claim 1, wherein the arrangement B is information expressing upper weights and expresses the number of bits set at 1 with respect to the respective phonemes.

4. The method according to claim 1, wherein the arrangement C is information expressing upper weights and expresses a position set at 1 with respect to the respective phonemes.

5. The method according to claim 1, wherein the arrangement D expresses quotients obtained by dividing the phoneme indexes by 8, which is a unit of expression.

6. The method according to claim 1, wherein the arrangement E expresses remainders Ls of quotients obtained by dividing the phoneme indexes by 8, which is a unit of expression.

7. The method according to claim 1, wherein the arrangement F expresses remainders Ls of quotients obtained by dividing the phoneme indexes by 8, which is a unit of expression, in terms of an exponent of 2, i.e., 2^{L}.

8. A method for constructing an acoustic model in a speech recognition system comprising:
an arrangement A constructed by allowing N phonemes to correspond to respective bits in N/8−1 bytes;
an arrangement M constructed by arranging weights that correspond to upper N/2 of N phonemes in an order of phoneme indexes;
an arrangement B expressing weight indexes that correspond to upper N/2 in terms of the number of bits set at 1;
an arrangement C expressing positions set at 1;
an arrangement D expressing quotients obtained by dividing the phoneme indexes by 8;
an arrangement E expressing remainders obtained by dividing the phoneme index by 8; and
an arrangement F expressing remainders Ls of the quotients obtained by dividing the phoneme indexes by 8 in terms of F[L]=2^{L}.

9. An acoustic modeling-based exploring method in a speech recognition system, the method comprising:
inputting a phoneme index;
exploring a relevant phoneme index position from an arrangement A expressing N phoneme index weights;
when the explored weight belongs to upper N/2 index weights, calculating the number S of information expressing the explored weight is a weight belonging to the upper N/2 index weights of up to the phoneme index position; and
exploring a weight for the S from an arrangement M[S] expressing upper weights in an order of original indexes with respect to respective phonemes.

10. The method according to claim 9, wherein a quotient K and a remainder L thereof obtained by dividing the phoneme index by 8 are calculated, a binary number in K-th byte with respect to the arrangement A is bit-operated (AND) with a binary number of 2^{L}, and when a result of the bit operation is greater than 1, it is judged that the phoneme index weight belongs to the upper N/2 index weights.

11. The method according to claim 9, wherein when the phoneme index weight dose not belong to the upper N/2 index weights, the phoneme index weight is replaced by a constant and stored.

12. The method according to claim 9, wherein when the explored phoneme index is positioned at an L-th bit of a K-th byte, the number of bits set at 1 when considering the range of up to a (K−1)th byte and the number of bits set at 1 when considering the range of up to a L-th bit of the K-th byte are summed to obtain the S.

13. The method according to claim 9, wherein the N=128.

14. An acoustic modeling-based exploring method in a speech recognition system, the method comprising:
setting an arrangement A constructed by allowing N phonemes to correspond to respective bits in N/8−1 bytes, an arrangement M constructed by arranging weights that correspond to upper N/2 of N phonemes in an order of phoneme indexes, an arrangement B expressing weight indexes that correspond to upper N/2 in terms of the number of bits set at 1, an arrangement C expressing positions set at 1, an arrangement D expressing quotients obtained by dividing the phoneme index by 8, an arrangement E expressing remainders of the quotient obtained by dividing the phoneme index by 8, and an arrangement F expressing remainders Ls of the quotients obtained by dividing the phoneme index by 8 in terms of F[L]=2^{L};
inputting a phoneme index;
obtaining a quotient K and a remainder L thereof calculated by dividing the inputted phoneme index by 8;
judging whether an operation result of A[K] AND F[L] is greater than 1 to judge whether the inputted phoneme has a weight that belongs to upper N/2 index weights;
when the judgment result is greater than 1, obtaining the number of bits set at 1 when considering the range of up to an L-th bit of a K-th byte using an operation J=A[K] AND C[L], and the number of bits set at 1 when considering the range of up to a K-th byte using an operation I=B[A[0]]+B[A[1]]+ . . . +B[A[K−1]]; and
obtaining I+B[J]=S from the operation results, and applying the S to the arrangement M to output M[S] as a exploring result for a phoneme index weight.
